(19) United States
(12) Patent Application Publication
(10) Pub. No.: US 2002/0126390 A1
(43) Pub. Date: Sep. 12, 2002

(54) Lens array substrate and image display device

(76) Inventors: Tomohiko Matsushita, Kyoto-shi (JP); Shigeru Aoyama, Kyoto-shi (JP); Daido Uchida, Kyoto-shi (JP); Yasuhiro Kawabata, Kyoto-shi (JP)

Correspondence Address: ROSENTHAL & OSHA L.L.P., 1221 MCKINNEY AVENUE, SUITE 2800, HOUSTON, TX, 77010, US

(21) Appl. No.: 10/054,087

(22) Filed: Jan. 22, 2002

(30) Foreign Application Priority Data
Jan. 22, 2001 (JP) 013624/2001

(51) Int. Cl. G02B 27/10

(52) U.S. Cl. 359/621; 359/619; 359/622; 359/623

(57) ABSTRACT

A multi-layered microlens array substrate is disclosed. The substrate includes a first layer having a plurality of microlenses disposed at an object side of the substrate, a second layer having a plurality of microlenses disposed at an image side of the substrate and attached to a liquid crystal device, and a third layer disposed between the first layer and the second layer. A refractive index of the third layer is different from that of the first layer and the second layer. A focal point of a compound lens formed by the second layer and the third layer is positioned proximate to an interface between the third layer and the first layer so that incident beams incidenting on the focal point from the object side of the substrate in different angles are refracted through the substrate in a manner that those incident beams are focused on a pixel of the liquid crystal device that is disposed at a position that corresponds to the microlens of the first and second layers.

### BACKGROUND OF INVENTION

The present invention relates to a lens array substrate and an image display device.

Recently, as a liquid crystal projector for projecting color images with a low cost without employing a color filter, a single-plate type liquid crystal color projector has been being used, which is constructed in such a manner that primary color beams color-decomposed by three dichroic mirrors, that is, R-beam, G-beam and B-beam, are incident on a single-plate type liquid crystal device on which pixels for expressing color-decomposed images of each of the three primary colors of R, G and B are arranged, to thereby display color images.

With the single-plate liquid crystal color projector, it is known that incident rays of light are focused on a desired pixel using a micro lens array (referred to as MLA hereinafter) constructed in a manner that a single focusing micro lens corresponds to three pixels of R, G and B in the single plate liquid crystal device in order to effectively admit rays of light into each pixel of the liquid crystal device and prevent deterioration in the quantity of transmitted light due to shielding of a black matrix.

FIG. 7 shows the configuration of a time division projector using a rotary color filter. The projector includes a projecting plane 91, a projection lens 92, a prism 93, a reflective image display device 94, a color filter 95 and an optical source 96. The projecting plane 91 is a screen on which an enlarged image is projected. The projection lens 92 is constructed of a plurality of lenses and magnifies the image from the reflective image display device. The prism 93 refracts time-divided beams from the color filter to the reflective image display device 94 and transmits the time-divided image to the projection lens 92. The reflective image display device 94 receives a beam from a reflecting plate (not shown) placed behind it to allow the liquid crystal display device to be turned on and off in connection with each of the three primary colors in time division. The color filter 95 turns filters of the three primary colors of red (R), green (G) and blue (B) with a motor. The optical source 96 is a white light source and employs a high-pressure mercury short arc lamp.

The operation of the aforementioned conventional projector is explained as follows. The color filter 95 revolving at a fixed speed receives white light from the optical source 96 to select colors. For example, the red filter selects only red light from the white light. This red light is refracted by the prism 93 and reflected from the reflecting plate in the reflective image display device 94 to project a beam corresponding to ON/OFF of the liquid crystal device. This beam enters the prism 93 and is magnified by the projection lens 92 to be projected on the projecting plane 91. This operation is processed in time division to project a color image.

FIG. 8 shows the configuration of a reflective liquid crystal display employing a conventional color filter. The display includes a projecting plane 100, a projection lens 101, a reflective display device 102, a color filter 103, a reflecting layer 104, and an optical source 105. The color filter 103 and the metal reflecting layer 104 for diffusion-reflecting a beam received through the color filter 103 are arranged behind the reflective display device 102 constructed of liquid crystal. Accordingly, white light from the optical source 105 is color-decomposed by the color filter and the resultant beam corresponding to each color is ON/OFF modulated by the reflective display device 102 and magnified by the projection lens 101 to be projected on the projecting plane 100.

Furthermore, a full color liquid crystal display has been known which employs a holographic color filter using spectral diffraction characteristic of hologram of diffraction grating, instead of the conventional color filter using dyes or pigments. This liquid crystal display is used for a liquid crystal video projector. For instance, it is known that a liquid crystal video projector in which the holographic color filter consists of hologram of microscopic dot corresponding to each color of red, green and blue, and a slit having a light-transmitting part is arranged to focus diffracted light corresponding to each color from the holographic color filter, to thereby project the light that has passed the slit on a screen as red, green and blue dots.

With the development of personal computer, communication techniques in relation to video become important more and more in the communication field. Recently, a text is made using a PC and formed on a liquid crystal plane to be directly projected on a projector for presentation, or liquid crystal TV pictures are enjoyed with a large-sized projector. In this situation, high picture quality is required because images rather than characters are frequently projected.

With the projector shown in FIG. 7, each of color images obtained by decomposing a color picture to be projected by the three primary colors is displayed on a single panel of the liquid crystal display device, a primary color beam corresponding thereto is incident on the panel, and the primary color beam image of each panel is projected on the screen, to thereby display the color picture. However, the color filter for obtaining the primary color beam accompanies a complicated rotating mechanism so that the intensity of the primary color beam incident on each liquid crystal device for time-division of each color becomes one third to darken the projected color picture.

In addition, with a beam inputted into the display device at an angle ax (inputted from the top of the right side), the product of the intensity and quantity of light of the reflected beam does not become the maximum with respect to the projection plane placed right in front of the display device but the product of the intensity and quantity of light in the mirror-reflection direction (toward the bottom of the right side) becomes the maximum. In this case, accordingly, utilization efficiency of incident beams participating in displaying images is lowered.

Furthermore, in case of hologram, the main beam is inputted obliquely to reduce optical efficiency and deteriorate color mixture rate. Moreover, this display device sensitively depends on the angle of the input beam.

### SUMMARY OF INVENTION

It is, therefore, an object of the present invention to provide a compact lens array substrate with high optical efficiency and an image display device employing the lens array substrate, capable of focusing and reflecting an incident beam from an optical source without loss.

To accomplish the object of the invention, there is provided a multi-layered microlens array substrate comprising: a first layer comprising a plurality of microlenses disposed at an object side of the substrate; and a second layer comprising a plurality of microlenses disposed at an image side of the substrate and attached to a liquid crystal device, the microlenses of the second layer being symmetrically aligned in relation to the micro-lenses of the first layer; and a third layer disposed between the first layer and the second layer, a refractive index of the third layer being different from that of the first layer and the second layer. A focal point of a compound lens formed by the second layer and the third layer is positioned proximate to an interface between the third layer and the first layer so that incident beams incidenting on the focal point from the object side of the substrate in different angles are refracted through the substrate in a manner that those incident beams are focused on a pixel of the liquid crystal device that is disposed at a position that corresponds to the microlenses of the first and second layers.

Here, the object side means a side of the substrate where beams come from. The image side means a side of the substrate where the beams are projected to.

According to the present invention, because the focal point of the compound lens formed by the second layer and the third layer is adapted to be positioned near on the interface between the third layer and the first layer, a beam inputted through the first layer is projected to the image side as a parallel main beam as long as the beam pass through the focal point. In addition, incident beams inputted into the object lens plane parallel with the main beam are focused on a focal point of the image forming side. Furthermore, parallel beams from an object side inputted into the object lens plane are focused on the focal point of the image forming side. Accordingly, it is possible to focus most of incident beams inputted from the object side on the image forming side so as to reduce loss of light and provide a bright optical system.

According to the present invention, the beams focused on the image forming side can be used for a transmission liquid crystal display device or reflective liquid crystal display device. In the transmission liquid crystal display device, it is preferable to arrange a liquid crystal panel having a transparent glass formed on both sides thereof behind the lens array substrate. In the reflective liquid crystal display device, it is preferable that a glass substrate is placed on the backside of the liquid crystal panel and a reflection plate is formed on the glass substrate and liquid crystal layer.

The liquid crystal display is designed in a manner that the composite focal distance of primary color beams accords with the pixel plane according to the lens array at beam incident side and the lens array at the beam projecting side. Accordingly, each color beam is focused on the pixel plane without loss and its reflected beam becomes parallel with the incident beam.

Furthermore, since the focal distance of main beams of colors is placed on the optical axis of the object lenses, the main beams pass through the optical axis to be vertically incident on the pixel plane and their reflected beams go through the same trace of the main beams.

According to the present invention, it is possible to employ an optical system of decomposing a beam from a white light source into the three primary colors and simultaneously admitting beams of the colors. Thus, a bright optical system without optical loss due to time division or color filter can be realized. Furthermore, the main beam is vertically inputted into and focused on the liquid crystal so that the beam spot is concentrated to result in reduction in color mixture rate meaning beam leakage into neighboring pixels. Accordingly, the liquid crystal plane can receive almost 100% of beam.

Moreover, the traces of beams can be estimated in advance and the optical system can be designed corresponding thereto because the incident beam and projected beams are in the same direction or the projected beam is in a predetermined direction. This makes the optical system compact and facilitates the design of the system.

The object lens and image lens of the lens array substrate may have convex curved surfaces toward the outside of the lens array substrate. In addition, a transparent resin layer having a refractive index smaller than that of the transparent resin forming the lens array substrate may be placed on the outer side of the first layer and the second layer. According to this structure, possibility of contact of the convex surfaces of the lenses, which have an important role in focusing beams, is low so that the lens array substrate can be fabricated thin.

The microlenses of the first layer and second layer can be constructed of an aspheric surface lens that satisfies the following expression (1) when the axis perpendicular to the plane of the lens array substrate on which the unit lenses are arranged is z-axis, axes parallel with the plane but perpendicular to each other are x- and y-axes, curvature on the optical axis is C, and conical coefficient is k.

$$F ( x , y , z ) = z - {CH}^{2} / ( 1 + \sqrt{1 - ( k + 1 ) {C}^{2} {H}^{2}} ) - {\sum }_{i = 2}^{10} {AiH}^{i}$$

(Here, H²=x²+y², C=1/R and A is a constant)

The aspheric surface is a rotating curved surface obtained by rotating F(x,y,z) around the optical axis when the coordinate axis of the direction of optical axis is z, the coordinate axes of the directions perpendicular to the direction of optical axis are x and y, and the lens plane on the optical axis corresponds to the aforementioned expression (1). Accordingly, the shape of the aspheric surface can be determined by the conical coefficient k.

According to the present invention, spherical aberration generated when a curved surface is used can be removed using a single lens and clear pictures can be formed because of small beam spot size.

The image lens or object lens may be constructed of a toric lens having different radiuses of curvature on x-axis and y-axis that are parallel with the plane of the lens array substrate having the unit lenses but perpendicular to each other.

The toric surface, which is a curved surface obtained by rotating a circular arc (whose center is not on a rotation axis) on a plane including the rotation axis, can form an image having the smallest aberration with respect to a pixel shape whose length and breadth are different from each other. Furthermore, with this toric surface, the lens can be freely designed without restriction.

The object lens or image lens can be constructed of a spherical lens that satisfies the following expression (2) when the axis perpendicular to the plane of the lens array substrate having the unit lenses is z-axis, axes parallel with the plane but perpendicular to each other are x- and y-axes, and curvature is C.

$$F ( x , y , z ) = z - C {H}^{2} / ( 1 + \sqrt{1 - {C}^{2} {H}^{2}} ) = 0$$

(Here, H²=x²+y² and C=1/R)

According to related techniques, the spherical lens can be easily manufactured, especially, its surface can be polished with high precision even using a lens polisher that is not so accurate. Furthermore, the spherical lens is easily designed.

In the lens array of the present invention, a transparent resin layer having a refractive index different from that of the lens array substrate may be placed on at least one side of the lens array substrate.

The focal distance of the lens array is changed according to the refractive index of the lenses using various methods including a method of controlling the focal distance depending on refractive index ratio of transparent resin layers, a method of varying curvature of the lens array, and a method of suitably combining the two methods.

According to related techniques, a plurality of lenses having different refractive indexes can be fabricated according to forming and the combination of refractive indexes can be changed without restriction. This allows the lens array to be freely designed.

In the present invention, the side of a first substrate having the image lens placed on one side thereof and the side of a second substrate having the object lens placed on one side thereof, opposite to the sides having the lenses, are attached to each other using a transparent resin adhesive or ultraviolet-hardening resin. It should be noted in this fabrication process that the positions of the substrates are properly aligned with each other, alien substances or bubbles are not introduced and equipment environments are prepared even when the lens array pattern is formed by a stamper.

According to related techniques, a multilevel lens array substrate can be manufactured in such a manner that a lens array is fabricated using the stamper, the lens array is inserted between optical glasses to be supported by them to construct a lens array substrate, and multiple lens array substrates made in this way are attached using a transparent resin adhesive. Furthermore, one of the optical glasses perpendicular to the optical axis can be omitted to fabricate a lens array with low cost. Moreover, the lens array can be manufactured using a developing equipment to increase investment efficiency. Also, a lens array having strong environment-resistance can be realized in terms of the performance thereof.

According to the present invention, there is provided an image display device including a transmission liquid crystal display device having a plurality of pixels, a color separating means for color-separating a beam emitted from a white light source and reflecting the separated color beams at predetermined angles, respectively, and an optical means for receiving the color beams to focus them on each pixel of the transmission liquid crystal display device, in which the optical means has a plurality of first lenses placed at the side of the transmission liquid crystal display device and a plurality of second lenses arranged at the side of the color separating means corresponding to the first lenses respectively, the focal point of the first lenses being placed near on the plane of the second lenses, and a first incident beam including a main beam inputted through the focal point from the color separating means and beams parallel with the main beam and a second incident beam including a main beam inputted through the focal point from a direction different from the direction of the first incident beam and beams parallel with the main beam are focused within a predetermined effective range of the transmission liquid crystal display device.

According to the invention, because the focal point of the first lenses is placed near on the plane of the second lenses, a beam inputted from the color separating means is projected as a parallel main beam as long as the beam pass through the focal point. In addition, incident beams inputted into the second lens plane parallel with the main beam are focused on the focal point of the image forming side of the first lenses. Furthermore, parallel beams inputted into the second lens plane from the color separating means are focused on the focal point of the transmission liquid crystal display device.

Accordingly, it is possible to focus most of incident beams inputted from the color separating means on the transmission liquid crystal display device so as to reduce optical loss and provide a bright optical system.

Furthermore, there is provided an image display device including a reflective liquid crystal display device having a plurality of pixels, a color separating means for color-separating a beam emitted from a white light source and reflecting the separated color beams at predetermined angles, respectively, and an optical means for receiving the color beams to focus them on each pixel of the reflective liquid crystal display device, in which the optical means has a plurality of first lenses placed at the side of the reflective liquid crystal display device and a plurality of second lenses arranged at the side of the color separating means corresponding to the first lenses respectively, the focal point of the first lenses being placed near on the plane of the second lenses, and a first incident beam including a main beam inputted through the focal point from the color separating means and beams parallel with the main beam and a second incident beam including a main beam inputted through the focal point from a direction different from the direction of the first incident beam and beams parallel with the main beam are focused within a predetermined effective range of the reflective liquid crystal display device.

According to the invention, because the focal point of the first lenses is placed near on the plane of the second lenses, a beam inputted from the color separating means is projected as a parallel main beam as long as the beam pass through the focal point. In addition, incident beams inputted into the second lens plane parallel with the main beam are focused on the focal point of the image forming side of the first lenses. Furthermore, parallel beams inputted into the second lens plane from the color separating means are focused on the focal point of the reflective liquid crystal display device.

Accordingly, it is possible to focus most of incident beams inputted from the color separating means on the reflective liquid crystal display device. In addition, the display device is constructed in a manner that the focused beams are reflected by a reflecting plate on a projection lens through the reflective liquid crystal display device so that optical loss can be reduced and a bright optical system can be provided.

The image display device of the invention does not requires a color filter for admitting each color beam into the liquid crystal display device individually because the white beam is color-decomposed by dichroic mirrors. In addition, utilization efficiency of incident beams is improved.

In the image display device of the invention, an angle widening for allowing incident beams and projected beams to be parallel with each other becomes smaller and the entire beam can be effectively used even when a projection lens with a small diameter is employed. Accordingly, light utilizing efficiency is increased and color images with satisfactory white balance can be obtained. Furthermore, the image display device does not necessarily need an expensive lens with large diameter so that the manufacturing cost of the projection color liquid crystal display can be reduced.

Moreover, the lens system used for the lens array substrate in both of the image display device employing the transmission liquid crystal display device and the image display device employing the reflective liquid crystal display is preferably constructed in a manner that the effective surface of the second lens facing the color separating means can receive all of primary color beams separated by the color separating means and the effective surface of the first lens facing the liquid crystal layer can project all of the primary color beams. Here, it is preferable that a first color projected from the effective surface of the first lens is focused on the center of the effective surface and colors other than the first color are focused on the area surrounding the effective surface. When the other colors are multiple colors, the surrounding area can shared by them or it may be divided into ring shaped regions around the center.

Meantime, the present invention also provides a method of controlling beams in a lens array substrate having a plurality of unit lenses formed of transparent resin, in which a plurality of image lenses are placed on one side of the lens array substrate and a plurality of object lenses are located on the other side, respectively corresponding to the image lenses, the focal point of the image lenses being placed near on the plane of the object lenses, and an optical path is determined such that a first incident beam including a main beam inputted into the object lenses through the focal point from a predetermined direction and beams parallel with the main beam and a second incident beam including a main beam inputted into the object lenses through the focal point from a direction different from the direction of the first incident beam and beams parallel with the main beam are focused together within a predetermined effective range of an image forming side.

Accordingly, most of the incident beams inputted from the object side can be focused on the image forming side so as to reduce optical loss and provide a bright optical system.

The present invention provides a method of controlling beams in an image display device including a liquid crystal display device having a plurality of pixels, a color separating means for color-separating a beam emitted from a white light source and reflecting the separated color beams at predetermined angles, respectively, and an optical means for receiving the color beams to focus them on each pixel of the liquid crystal display device, in which the optical means has a plurality of first lenses placed at the side of the liquid crystal display device and a plurality of second lenses arranged at the side of the color separating means corresponding to the first lenses respectively, the focal point of the first lenses being placed near on the plane of the second lenses, and an optical path is determined such that a first incident beam including a main beam inputted through the focal point from the color separating means and beams parallel with the main beam and a second incident beam including a main beam inputted through the focal point from a direction different from the direction of the first incident beam and beams parallel with the main beam are focused together within a predetermined effective range of the reflective liquid crystal display device. Accordingly, a bright image display device with reduced optical loss can be realized.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates the cross section of a reflective liquid crystal display device having an MLA substrate according to the present invention and the traces of beams;

FIG. 2 is a diagram for explaining the traces of beams of FIG. 1 in more detail;

FIG. 3 is a perspective view of a lens having aspheric surface;

FIG. 4 illustrates a combination of prominence and depression patterns of MLA;

FIG. 5 illustrates various structures of MLA;

FIGS. 6(a) and 6(b) illustrate the structures of a reflective color liquid crystal display device and a transmission color liquid crystal display device according to first and second embodiments of the invention, respectively;

FIG. 7 illustrates the configuration of a time-division type projector using a conventional rotary color filter; and

FIG. 8 illustrates the configuration of a reflective liquid crystal display using a convention color filter.

### DETAILED DESCRIPTION

The present invention will now be described in connection with preferred embodiments with reference to the accompanying drawings. Such description is not intended to be understood in a limiting sense, but to be an example of the invention presented solely for illustration thereof, and by reference to which in connection with the following description and the accompanying drawings one skilled in the art may be advised of the advantages and construction of the invention.

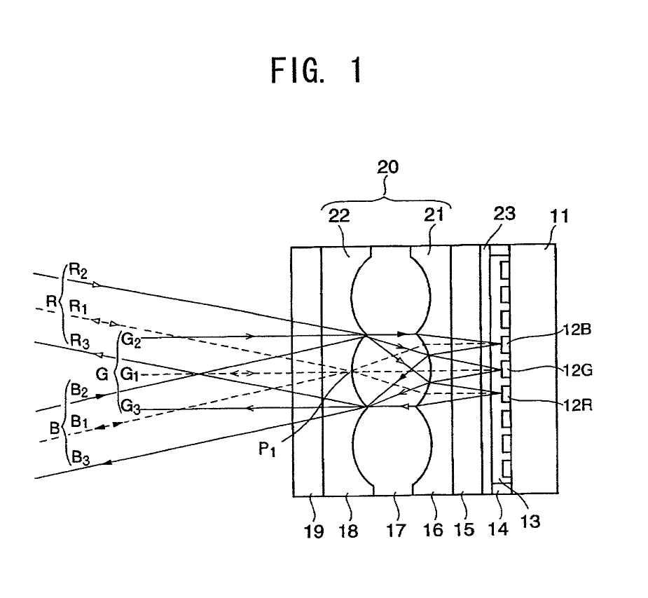

FIG. 1 shows the cross section of a reflective liquid crystal display device 10 with a MLA used for a reflective color liquid crystal display of the present invention and the traces of beams. The reflective liquid crystal display device 10 is constructed in such a manner that a transparent scan electrode 23 and driving electrodes 12R, 12G and 12B are respectively formed on the sides of a base glass 15 that is disposed outside of the MLA substrate 20 and a glass substrate 11 opposite to each other, having a liquid crystal layer 13 filled between them, and both ends are sealed with a sealant 14.

The MLA substrate 20 has transparent three lens resin layers 18, 17 and 16 having different refractive indices between base glasses 19 and 15, having interface between neighboring lens resin layers.

The transparent scan electrode 23 and driving electrodes 12R, 12G and 12B are formed perpendicularly to each other. That is, the electrodes are arranged in a matrix form and, when the crossing is selected, the portion of the liquid crystal layer 13, corresponding to the driving electrode, transmits rays of light according to phase rearrangement. The driving electrodes 12R, 12G and 12B are formed corresponding to the three primary colors of red, green and blue to mix the colors to make all colors, driving one pixel of the liquid crystal.

The focal point P1 of the compound lens of the second lens 21 and the lens resin layer 17 is positioned proximate to the interface between the first lens 22 and the lens resin layer 17. The first lens 22 and the second lens 21 are configured such that the parallel beams incidenting from the base glass 19 of the first lens 22 to the focal point PI pass the first lens 22 and the second lens 21 and focus on the driving electrodes 12R, 12G, 12B or their proximate area.

Next, the traces of beams that pass the first lens 22 and the second lens 21 are explained. A main beam is indicated by a dotted line and colors are designated by red R, green G and blue B. As shown in FIG. 1, the main beams R1, G1, B1 of these colors are incidented on the first lens (object side lens) 22 from different angles and pass through the second lens 21. The incidenting angle of these beams are set such that these beams incident on the driving electrodes 12R, 12G, 12B. Under this configuration, if the main beams of these colors are incidented to the focal point PI of the compound lens, these main beams are output from the second lens 22 in parallel to each other even if these beams are incidented from different angles. By disposing the driving electrodes 12R, 12G, 12B, perpendicularly to these parallel beams, the main beams of these colors are incidented perpendicularly to these driving electrodes 12R, 12G, 12B. If an imaginary reflection mirror is disposed at the driving electrode side of the glass substrate 11 perpendicularly to these parallel beams, the beams incidented to the electrodes 12B, 12G, 12R and reflected by the imaginary reflection mirror pass the same traces as the traces of the incidenting beams and focus on the focal point P1.

The color beams R2, G2, B2 that are in parallel with the main beams RI, G 1, B 1 are incidented to the first lens 22 to be refracted by the first lens 22 and the second lens 21 and incidented on the driving electrodes 12R, 12G and 12B or their proximate area. If an imaginary reflection mirror is disposed at the driving electrode side of the glass substrate 11, the beams incidented to the electrodes 12B, 12G, 12R and reflected by the imaginary reflection mirror pass in a direction that is symmetrical to the main beams. Accordingly, the reflected beams passing through the second lens 21 and the first lens 22 are refracted such that beams R3, G3, B3 are output in parallel with the color beams R2, G2, B2.

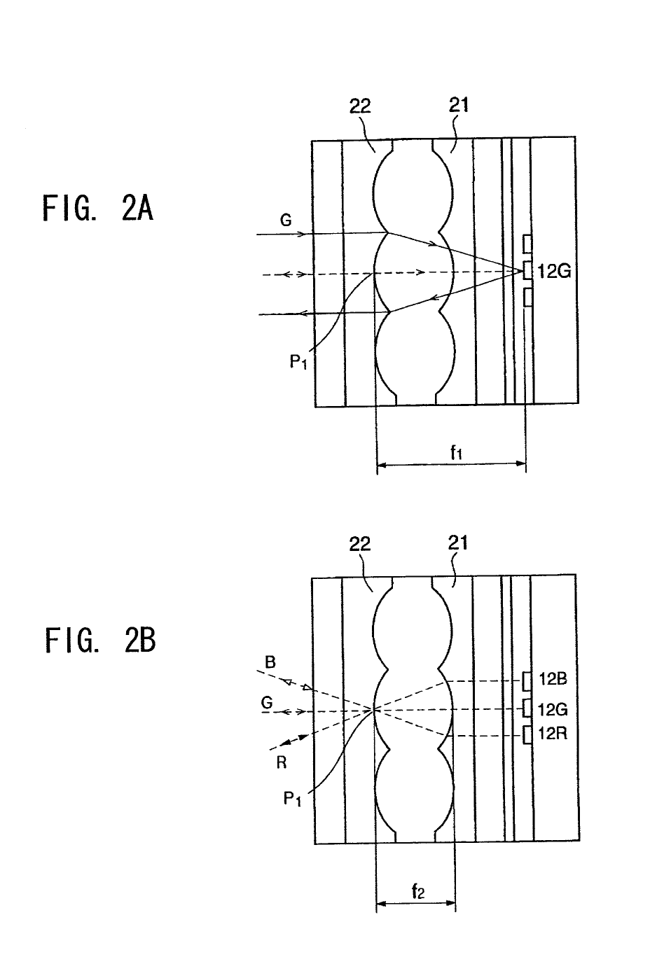

FIG. 2 is a diagram for explaining the traces of the beams of FIG. 1 in more detail. The case of green beam is described with FIG. 2(a), for example. The input beam and reflected beam of the main beam indicated by a dotted line pass through the same trace, and the other beam is refracted by the first lens 22 and further refracted by the second lens 21 to be focused on the driving electrode 12G. This is equivalent to a lens having the composite focal distance f1 of the first lens 22 and the second lens 21.

FIG. 2(b) is a diagram for explaining the traces of beams of FIG. 1 in more detail. The main beam of each color is vertically incident on corresponding driving electrode 12R, 12G or 12B and its reflected beam passes through the same trace of the main beam so that the main beams of colors become parallel with one another. The liquid crystal display device is designed in a manner that these parallel beams are inputted into the second lens 21 such that their focal distance f2 accords with the optical axis of the first lens 22.

According to the above-described lens array, the beams of three primary colors obtained by decomposing white light can be incident on one pixel of liquid crystal simultaneously so that loss of light due to time division or color filter can be prevented and bright optical system can be realized. Furthermore, since the main beams are vertically inputted and focused on the liquid crystal, the color mixture rate that means beam leakage into neighboring pixels is reduced and the liquid crystal plane can receive nearly 100% of beam.

Moreover, the trace of beam can be estimated in advance because the incident beam and projected beam are in the same direction or the projected beam is in a predetermined direction, so that a compact optical system can be easily designed corresponding thereto.

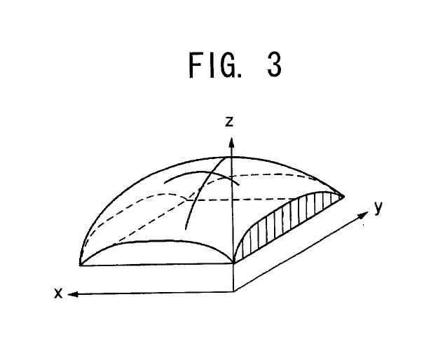

FIG. 3 is a prospective view of a lens in case of a MLA with aspheric surface. The aspheric surface is a rotating curved surface obtained by rotating a lens surface around an optical axis. The lens surface is represented by the following expression (1) when the coordinate axis of the direction of optical axis is z, the coordinate axes of the directions perpendicular to the direction of optical axis are x and y, curvature on the optical axis is C, and conical coefficient is k.

$$F ( x , y , z ) = z - {CH}^{2} / ( 1 + \sqrt{1 - ( k + 1 ) {C}^{2} {H}^{2}} ) - {\sum }_{i = 2}^{10} {AiH}^{i}$$

(Here, H²=x²+y², C=1/R and A is a constant)

The effects accomplished by the aspheric surface include 1) removal of spherical aberration, 2) removal or reduction of astigmatism, 3) control of distortion aberration, 4) balancing aberration for improvement of overall performance without a specific aberration and 5) beam deflection.

The lens in this embodiment is designed for obtaining the effects 1) and 4). According to this, a single lens with small spherical aberration can be realized.

In FIG. 3, furthermore, it is possible to realize a lens with high light efficiency by using a toric lens having x and y axes with different radiuses of curvature, which is represented by the following expressions.

$$F ( x , z ) = z - {Cx}^{2} / ( 1 + \sqrt{1 - ( k + 1 ) {C}^{2} {x}^{2}} ) - {\sum }_{i = 2}^{10} {Aix}^{i} = 0$$

(Here, C=1/R and A is a constant)

$$F ( y , x ) = z - {Cy}^{2} / ( 1 + \sqrt{1 - ( k + 1 ) {C}^{2} {y}^{2}} ) - {\sum }_{i = 2}^{10} {Aiy}^{i} = 0$$

(Here, C=1/R and A is a constant)

Moreover, it is possible to easily realize an optimum lens with a simple design by using a spherical lens whose lens surface satisfies the following expression.

F(x,y,z)=z−CH²/(1+\sqrt{1−C²H²})=0 (2)

(Here, H²=x²+y² and C=1/R)

Furthermore, it is possible to construct an optical system having a spot diameter reduced as narrow as possible by removing aberration using at least two spherical lenses described above.

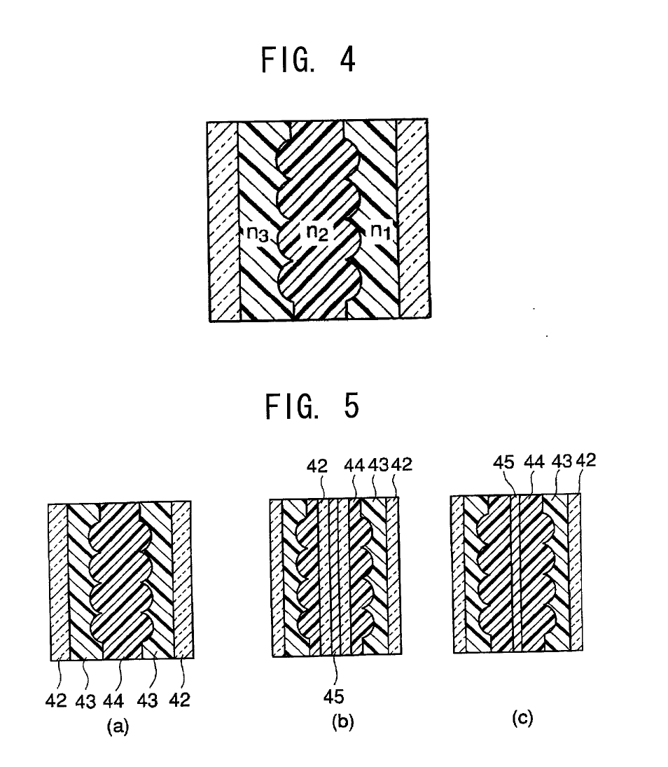

FIG. 4 illustrates the combination of prominence and depression patterns of the MLA. The lens array substrate having multiple lenses in this embodiment is constructed in such a manner that a plurality of transparent resin layers having different refractive indexes are laminated to combine the interfaces between neighboring resin layers. This lens array substrate can be manufactured in a manner that the multiple transparent resin layers are not attached to one another but they are laminated to be integrated.

The combination of the transparent resin layers having different refractive indexes, for example, the three resin layers having refractive indexes n₁, n₂ and n₃ shown in FIG. 4, can include a case where the refractive index of the central transparent resin layer is larger than those of the resin layers placed at both sides thereof (n₂>n₁, n₂>n₃), a case where the refractive index of the central transparent resin layer is smaller than those of the resin layers placed at both sides thereof (n₂<n₁, n₂<n₃), a case of n₁<n₂<n₃, and a case of (n₁<n₂,n₂>n₃).

In case that the plurality of transparent resin layers are fabricated by forming as described in this embodiment, the combination of refractive indexes can be changed without restriction and the lens array substrate can be freely designed. Especially, in case of the combination of refractive indexes of n₂>n₁ and n₂>n₃ or n₂<n₁ and n₂<n₃, the refractive indexes n₁ and n₃ may be identical to each other. That is, the number of fabrication steps for manufacturing the lens array substrate can be reduced because the lens array substrate can be constructed of only two kinds of transparent resin layers. Furthermore, the central resin layer has a convex lens shape as shown in FIG. 4 in case of n₂>n₁ and n₂>n₃, and it is in a concave lens shape with n₂<n₁ and n₂<n₃.

In case of n₂>n₁ and n₂>n₃, it is effective that the transparent resin layers at both sides are first formed and then the central resin layer is inserted therebetween to fabricate the lens array substrate. By doing so, even a transparent resin with high viscosity for forming the central resin layer can be uniformly distributed between the resin layers placed at both sides thereof without generating bubbles. Accordingly, the lens array substrate with high optical efficiency can be constructed. Moreover, possibility of contact of curved surfaces of concave lenses that play an important role in focusing beams is low even when the central resin layer is thin. This results in realization of a thin lens array substrate.

FIG. 5 illustrates the structure of the MLA. FIG. 5(a) shows a double MLA structure constructed in a manner that optical glasses 42 and sealing resin layers 43 are placed on both sides of a central lens resin layer 44 being inserted between them. This structure is strongly environment-resistant because the lens resin is sealed by the optical glass and sealing resin. The structure of FIG. 5(b) is formed in such a manner that the curved surface of the lens resin layer 44 is sealed by the sealing resin 43 and this lens resin layer is inserted between the optical glasses 42 to obtain a lens chip, and two lens chips made in this way are attached to each other using a transparent adhesive 45. The transparent adhesive may be replaced by an ultraviolet-hardening resin. This structure also has strong environment-resistance. The structure shown in FIG. 5(c) is obtained by omitting the optical glass on the adhesion surface of the two lens resin layers. This structure can be made with a low cost.

In addition, the lens may be formed of only a resin layer or only a lens resin layer and sealing resin. In this case, two-layer MLA can be formed between two base glasses through a photo-polymerization method using an ultraviolet-hardening resin.

According to the MLA structures of the present invention, an optical system having desired characteristics can be easily realized.

Next, an image display device using the MLA substrate of the invention is explained.

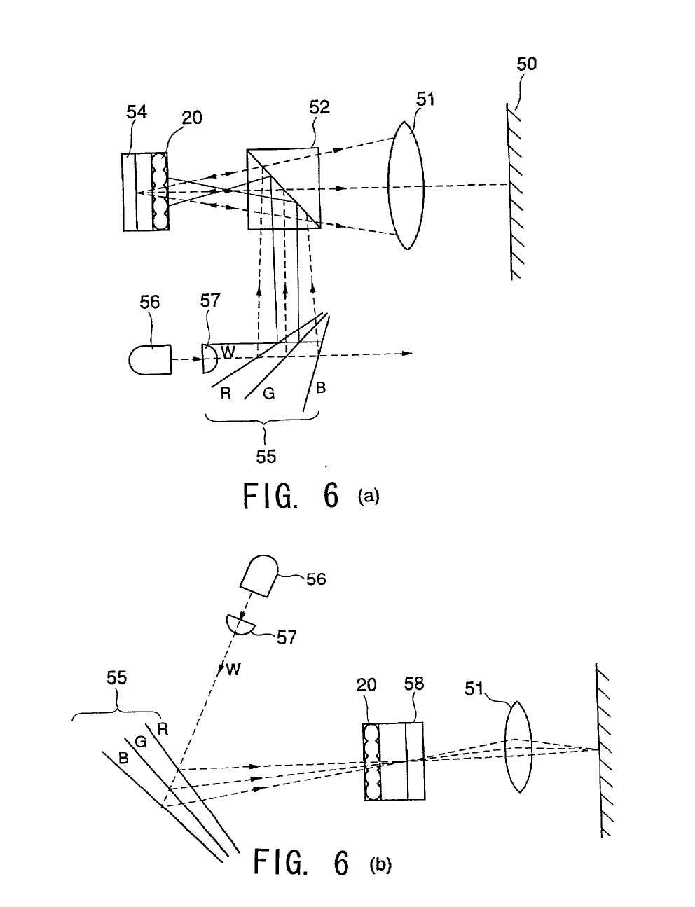

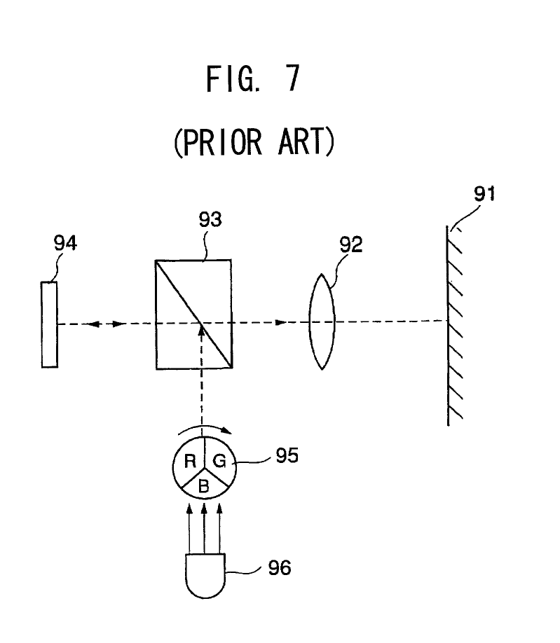

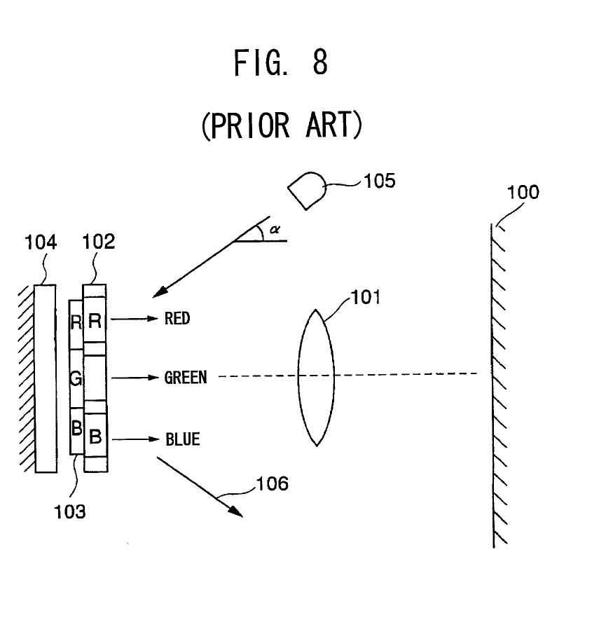

FIG. 6(a) illustrates the structure of a reflective color liquid crystal display according to a first embodiment of the invention. In this color liquid crystal display, a spherical mirror (not shown) is placed behind a white light source 56 in such a manner that the center of the spherical mirror accords with the center of a light-emitting portion of the white light source 56. A condenser lens 57 is set in front of the white light source 56, with the center thereof according with the center of the light-emitting portion of the white light source 56. A white beam W emitted from the white light source 56 or a white beam W emitted from the white light source 56 and reflected from the spherical mirror passes through the condenser lens 57 to become a nearly parallel white beam W.

In addition, three kinds of dichroic mirrors 55R, 55G and 55B are arranged at different angles in front of the condenser lens 57. These dichroic mirrors 55R, 55G and 55B selectively reflect only beams of wavelength ranges corresponding to red, green and blue, respectively, but transmit beams of other wavelength range. The dichroic mirrors are arranged in the order of the red mirror 55R, green mirror 55G and blue mirror 55B from the condenser lens side. Here, R, G and B mean red, green and blue, respectively.

The wavelength ranges of red, green and blue respectively correspond to 400˜495 nm, 495˜575 nm and 570˜700 nm, approximately. When the entire beams of each wavelength range are used, illuminance increases but color purity of each primary color decreases. Thus, beams of wavelength near 495 n, and 575 nm may be cut in case where the color purity is important.

The dichroic mirrors 55R, 55G and 55B are formed by a well-known multilevel thin film coating technique. The condition of a multilevel thin film used for the red dichroic mirror 55R is established such that the red dichroic mirror reflects visual rays of wavelengths longer than 600 nm approximately. The condition of a multilevel thin film for the blue dichroic mirror 55B is set such that the blue dichroic mirror reflects visual rays of wavelengths shorter than 500 nm approximately. The condition of a multilevel thin film for the green mirror 55G is established such that the green dichroic mirror reflects visual rays of wavelengths of 570˜500 nm approximately. Furthermore, any of the dichroic mirrors 55R, 55G and 55B can be designed to transmit infrared rays. In this case, an increase in the temperature of the liquid crystal display 54 can be mitigated because the infrared rays cannot reach the liquid crystal display.

The white beam W that has passed through the condenser lens 57 is incident on the dichroic mirrors 55R, 55G and 55B to be decomposed into red, green and blue beams and inputted into a prism 52. These beams are further refracted by the prism to reach the MLA 20 placed on the liquid crystal display device 54. The MLA 20 has the configuration using two lenses as shown in FIG. 1. This is able to realize an optical system that vertically admits main beams into each pixel and focuses each beam on the pixel to project the beams within the effective range. That is, beams spatially separated are focused on each pixel of liquid crystal to be projected in the same direction of input beams. Accordingly, the projected beams transmit the prism 52 and are magnified by a projection lens 51 to be projected on a screen 50.

FIG. 6(b) illustrates the structure of a transmission color liquid crystal display according to a second embodiment of the invention. In the views of FIGS. 6(a) and 6(b), like reference characters designate like or similar parts so that explanations for them are omitted.

The liquid crystal display shown in FIG. 6(b) has no prism 52 of the display of FIG. 6(a). In addition, it has the projection lens 51 and screen 50 placed behind the transmission liquid crystal display 58. In this structure, the white beam W that has passed through the condenser lens 57 is incident on the dichroic mirrors 55R, 55G and 55B to be decomposed into red, green and blue beams and inputted at predetermined angles into the MLA 20 placed on the liquid crystal display device 58. The MLA 20 has the characteristics described above so that the beams outputted therefrom transmit a transparent signal electrode (not shown) of the liquid crystal display device 58 and are magnified by the projection lens 51 to be projected on the screen 50.

The MLA substrate of the invention can be used for applications of image display device such as a projection-type projector, a back surface projecting projector TV, a head mount display, a view finer, a mobile phone and so on.

As described above, according to the present invention, the lens array substrate can focus most of beams inputted from an object on the image display device and provide a bright optical system with reduced optical loss. Therefore, these focused beams can be used for a transmission or reflective liquid crystal display device.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A multi-layered microlens array substrate comprising:
a first layer comprising a plurality of microlenses disposed at an object side of the substrate;
a second layer comprising a plurality of microlenses disposed at an image side of the substrate and attached to a liquid crystal device, the micro-lenses of the second layer being symmetrically aligned in relation to the micro-lenses of the first layer; and
a third layer disposed between the first layer and the second layer, a refractive of the third layer being different from that of the first layer and the second layer;
wherein a focal point of a compound lens formed by the second layer and the third layer is positioned proximate to an interface between the third layer and the first layer so that incident beams incidenting on the focal point from the object side of the substrate in different angles are refracted through the substrate in a manner that those incident beams are focused on a pixel of the liquid crystal device that is disposed at a position that corresponds to the microlens of the first and second layers.

2. A microlens array substrate comprising:
a plurality of microlenses formed on an image side of the substrate, each of the microlenses facing a pixel of a liquid crystal device that is attached to the image side of the substrate; and
a plurality of microlenses formed on an object side of the substrate disposed at positions corresponding to the plurality of micro-lenses on the image side of the substrate;
wherein a focal point of a micro-lens on the image side of the substrate is positioned proximate to a surface of a microlens of the object side of the substrate so that incident beams incidenting on the focal point from the object side of the substrate in different angles are refracted through the substrate in a manner that those beams are focused on a pixel of the liquid crystal device at a position that corresponds to the microlenses of the substrate.

3. The substrate according to claim 1, wherein the micro-lenses of the first layer and the second layer are formed in a concave shape at interfaces with the third layer.

4. The substrate according to claim 2, wherein the microlenses of the substrate are formed in a convex shape.

5. The substrate according to claim 3, wherein the refractive index of the third layer is lower than that of the first layer and second layer.

6. The substrate according to claim 1, wherein the microlens of the first and second layers comprise an aspheric-surface lens that satisfies the following expression:
$$F ( x , y , z ) = z - {CH}^{2} / ( 1 + \sqrt{1 - ( k + 1 ) {C}^{2} {H}^{2}} ) - {\sum }_{i = 2}^{10} {AiH}^{i} = 0$$
(Here, H²=x²+y², C=1/R and A is a constant)
wherein the axis perpendicular to the plane of the lens array substrate having the microlens is z-axis, axes parallel with the plane but perpendicular to each other are x- and y-axes, curvature is C, and conical coefficient is k.

7. The substrate according to claim 1, wherein the microlenses of the first layer and the second layer comprise a toric lens having different radiuses of curvature on x-axis and y-axis, wherein the x-axis and y-axis are in parallel with the plane of the substrate and perpendicular to each other.

8. The substrate according to claim 1, wherein the microlens of the first layer and the second layer comprise a spherical lens that satisfies the following expression:
F(x,y,z)=z−CH²/(1+\sqrt{1−C²H²})=0
(Here, H²=x²+y² and C=1/R)
wherein the axis perpendicular to the plane of the lens array substrate having the microlens is z-axis, axes that are parallel with the plane of the substrate and perpendicular to each other are x- axis and y-axis, and curvature is C.

9. The substrate according to claim 1, wherein a transparent resin layer having a refractive index different from that of the substrate is disposed at least at one side of the substrate.

10. The substrate according to claim 1, wherein a transparent resin adhesive layer is attached to both sides of the substrate, or ultraviolet-hardening resin.

11. The substrate according to claim 1, wherein an ultraviolet-hardening resin layer is attached to both sides of the substrate.

12. An image display device comprising a liquid crystal display element having a plurality of pixels and a multi-layered microlens array substrate, the substrate further comprising:
a first layer comprising a plurality of microlenses disposed at an object side of the substrate and;
a second layer comprising a plurality of microlenses disposed at an image side of the substrate and attached to a liquid crystal device, the micro-lenses of the second layer being symmetrically aligned in relation to the micro-lenses of the first layer;
a third layer disposed between the first layer and the second layer, a refractive index of the third layer being different from that of the first layer and the second layer;
wherein a focal point of a compound lens formed by the second layer and the third layer is positioned proximate to an interface between the third layer and the first layer so that incident beams incidenting on the focal point from the object side of the substrate in different angles are refracted through the substrate in a manner that those incident beams are focused on a pixel of the liquid crystal device that is disposed at a position that corresponds to the microlens of the first and second layers.

13. An image display device comprising a liquid crystal display element having a plurality of pixels and a multi-layered microlens array substrate, the substrate further comprising:
a plurality of microlenses formed on an image side of the substrate, each of the microlenses facing a pixel of a liquid crystal device that is attached to the image side of the substrate; and
a plurality of microlenses formed on an object side of the substrate disposed at positions corresponding to the plurality of micro-lenses on the image side of the substrate;
wherein a focal point of a micro-lens on the image side of the substrate is positioned proximate to a surface of a microlens of the object side of the substrate so that incident beams incidenting on the focal point from the object side of the substrate in different angles are refracted through the substrate in a manner that those beams are focused on a pixel of the liquid crystal device at a position that corresponds to the microlenses of the substrate.

14. A method of controlling beams in a lens array substrate having a plurality of unit lenses formed of a transparent resin,
wherein a plurality of image lenses are placed on one side of the lens array substrate and a plurality of object lenses are located on the other side, respectively corresponding to the image lenses, the focal point of the image lenses being placed near on the plane of the object lenses, and an optical path is determined such that a first incident beam including a main beam inputted into the object lenses through the focal point from a predetermined direction and beams parallel with the main beam and a second incident beam including a main beam inputted into the object lenses through the focal point from a direction different from the direction of the first incident beam and beams parallel with the main beam are focused together within a predetermined effective range of an image forming side.

15. A method of controlling beams in an image display device including a liquid crystal display device having a plurality of pixels, a color separating means for color-separating a beam emitted from a white light source and reflecting the separated color beams at predetermined angles, respectively, and an optical means for receiving the color beams to focus them on each pixel of the liquid crystal display device,
wherein the optical means has a plurality of first lenses placed at the liquid crystal display device side and a plurality of second lenses arranged at the color separating means side, corresponding to the first lenses respectively, the focal point of the first lenses being placed near on the plane of the second lenses, and an optical path is determined such that a first incident beam including a main beam inputted through the focal point from the color separating means and beams parallel with the main beam and a second incident beam including a main beam inputted through the focal point from a direction different from the direction of the first incident beam and beams parallel with the main beam are focused together within a predetermined effective range of the liquid crystal display device.
